(19) United States
(12) Patent Application Publication
(10) Pub. No.: US 2019/0249649 A1
(43) Pub. Date: Aug. 15, 2019

(54) SYSTEM WITH AN APPARATUS ON A WIRE, METHOD OF ITS OPERATION, USE THEREOF AND A TOOL KIT

(71) Applicant: ROPE ROBOTICS APS, Abyhøj (DK)

(72) Inventors: MARTIN HUUS BJERGE, KIBÆK (DK); HANS LAURBERG, AARHUS C (DK)

(21) Appl. No.: 16/316,422

(22) PCT Filed: Jul. 7, 2017
(86) PCT No.: PCT/DK2017/050233

§ 371 Date: Jan. 9, 2019

(30) Foreign Application Priority Data
Jul. 12, 2016 (DK) PA 2016 70518

(51) Int. Cl. F03D 80/55

(52) U.S. Cl. CPC F03D 80/55

(57) ABSTRACT

A system, a method and a tool kit are provided including an apparatus on a wire, for example for cleaning or repairing a wind turbine blade. The apparatus includes a base and an arm, the arm extending from the base and including a remote end, the remote end and the base, each including an attachment device for securing to a surface.

### CROSS-REFERENCE TO RELATED APPLICATIONS

This application claims priority to PCT Application No. PCT/DK2017/050233, having a filing date of Jul. 07, 2017, which is based on DK Application No. PA 2016 70518, having a filing date of Jul. 12, 2016, the entire contents both of which are hereby incorporated by reference.

### FIELD OF TECHNOLOGY

The following relates to a system, especially used for cleaning and repair of vertical surface or inclined surface, of an offshore wind turbine, and a method of its operation. It also relates to a tool kit for the apparatus and use of the system.

### BACKGROUND

For cleaning or painting or maintenance of wind turbines blades, the known art discloses a number of systems for servicing outer components of wind turbines.

International patent application WO2004/092577 discloses a movable work platform for workers. The platform is hanging on a cable from a hoist in the nacelle and is attached to an arm that engages with the tower for gripping the tower or for sliding along the outside of the tower when lifting or lowering the platform. The distance between the tower and the platform can be adjusted by extending the arm.

In order to avoid personnel, automated devices have been proposed. An example is disclosed in European patent application EP2281770 in which multiple unmanned climbing vehicles are provided around the tower and pressed against the tower surface by wires around the tower and the vehicles. A friction pad on an arm of each vehicle is repeatedly extended from the respective vehicle and pressed against the tower surface below the vehicles for pushing the vehicles upwards. A maintenance tool is provided below the vehicles, for example for cleaning and painting.

Other systems, which are unmanned, are provided on wires fastened to the nacelle or the rotor. Examples are Korean patent applications KR20130114913, KR20140001444, KR20120067128, KR20140000370, and KR20140000383, as well as US patent application US2011318496A. These systems are relatively expensive in production due to their size and expensive to transport to the site. Smaller systems include robots that are sliding or crawling along the turbine blades while in horizontal orientation, for example as disclosed in International patent application WO2013/032166, US patent application US2010132137 and equivalent European patent application EP2752621, or Chinese utility model CN205129861U.

Another type of climbing robots for horizontal or vertical walls is disclosed in U.S. Pat. No. 5,551,525. Two similar arms with suction cups are connected to each other by a hinge, and one arm is fastened to a location while the other is moved and vice versa. A further type of climbing robot is disclosed in international patent application WO00/75000 in which a vehicle comprises an endless belt track with suction chambers for sucking the track against a surface. Optionally, a movable arm with a suction cup at its remote end is attached to the vehicle. When the arm is properly attached to the surface, it is capable of lifting the vehicle over obstacles.

None of these systems have been commercially successful. It appears that the market is still awaiting a small scale technical solution which is versatile, involves low-cost production, and is easy to transport from site to site.

For wind turbines among others, a vacuum stepper robot is disclosed in US patent application US2015/0107915. The robot comprises a base with multiple vacuum suction cups that move relatively to each other alternatingly.

For robots in general, relatively recent developments focus on synthetic dry adhesive in an attempt to mimic the feet of geckos, seeing that geckoes can crawl along vertical walls as well as upside down on ceilings. Examples of dry adhesives are disclosed in U.S. Pat. No. 7,762,362 and German patent application DE201510101290. Micro-structured dry adhesives are generally described and discussed in US2008/169003, US2014272272, and U.S. Pat. No. 8,882,996, referring to electrostatic and Van der Waals forces. In US2014272272, it is explained with reference to gecko feet that dry adhesives commonly use asymmetric micro-structured hairs that create a high area of contact when loaded in a preferred direction. When the load is reversed, the adhesives release from the surface with near zero force.

### SUMMARY

An aspect relates to a system which is simple to use, especially for cleaning and repair of surfaces, such as wind turbine blades, and which requires low cost in fabrication and which has a high level of versatility and adaptivity. This aspect is achieved with a system as explained in the following. It is a further aspect to provide methods for operating of the systems as well as advantageous use of such a system, especially of the various embodiments described.

The system comprises an unmanned apparatus and at least one wire, for example two or three wires, to which the apparatus is attached for holding the weight of the apparatus by the at least one wire. If only one wire is used, it is dimensioned to hold the entire weight of the apparatus. If more than one wire is used, for example two or three wires, it is sufficient that the wires are dimensioned to hold the weight in common. Typically, however, for safety reasons, even in the case of multiple wires, each wire would be dimensioned to hold the entire weight.

When the system is in in operation, the at least one wire is extending downwards from an anchor location at a level above the apparatus. A length adjustment mechanism is provided for adjusting the length of the at least one wire between the apparatus and the anchor location. This length adjustment can be used for thereby lifting or lowering the apparatus or for length adjustment of the wire when the apparatus is moved sideways and thereby changes the distance from the base to the anchoring location. Thus, the at least one wire is also a support when moving the apparatus sideways without necessarily lifting or lowering the apparatus.

The apparatus has a base and an arm extending from the base. The term “an arm” is used with the meaning of “at least one arm”. Multiple arms can be used for similar function, or multiple arms can have multiple functions. In the case of multiple arms, typically, the arms have different functions. For example, one arm is used for movements of the apparatus, as will be explained below, whereas a further arm is used for holding and operating various tools. Advantageously, in order to minimize weight and reduce production cost, however, only a single arm is used on the base. In cases where multiple arms are used with different functions, it is expressed as “an arm” and “a further arm”; in this case, the term “an arm” comprises one or more arms with the specific function described for this particular arm, and the term “further arm” comprises one or more further arms with the specific function of this particular “further arm”.

The arm is moveable relatively to the base and, thus has at least one degree of freedom relatively to the base. Typically, however, the arm has multiple degrees of freedom for movement relatively to the base, for example 2, 3, 4, 5, 6, 7, or 8, degrees of freedom with respect to movement relatively to the base. For example, this is achieved by a corresponding number of rotational actuators with one degree of freedom each. However, a single actuator can be provided with more than one degree of freedom, for example when provided as cooperating half spheres.

The base is configured for attachment to the at least one wire in order to change the elevation level of the base. The wire secures the apparatus against gravity at desired heights. In some embodiment, for the length adjustment mechanism, the base is provided with a dragging unit by which the base is dragged along the wire, for example selectively in an upwards or downwards direction. An example of a dragging unit with rollers between which the wire kept under pressure is disclosed in Korean patent application KR20140000383 by Samsung Heavy Ind.

As an alternative, the at least one wire is rolled onto at least one roller which is part of the base. In this case, the at least one wire does not hang further down than the apparatus. As a further alternative, the apparatus is secured to the at least one wire, for example to the end of the at least one wire, and the length adjustment mechanism comprises a wire hoist at elevated level above the apparatus, for example at the top of a wind turbine, which is used to lift the apparatus up and down as desired by winding up or rolling out the wire or wires.

The remote end of the at least one arm comprises an arm attachment device for securing the remote end stationary to a surface of an operation site. For being stationary secured, the arm attachment device is in contact with the surface. Similarly, the base comprises a base attachment device, which is different from the arm attachment device, for securing the base stationary to the surface. For being stationary secured, the base attachment device is in contact with the surface.

Examples of attachment devices are a suction cup, a dry adhesive pad, an electromagnetic pad, or an electrostatic pad, Velcro® pads, or sticky or high-friction pads. The term dry adhesive pad is here used for devices that exhibit adhesive behaviour as explained in the introduction above without using a liquid adhesive. Examples are devices that function similarly as gecko feet, for example comprising artificial nano-sized structures as disclosed in U.S. Pat. No. 7,762,362, U.S. Pat. No. 8,882,996, U.S. Pat. No. 8,398,909, US2014/272272, US2014/227473. It is pointed out that the base and arm attachment devices need not be of identical type but can be different.

Typically, the device is unmanned and of a weight and size not applicable for supporting personnel. Instead, it is intended to substitute work done by personnel.

The system is configured for a sequence of operations comprising,

adjusting the elevation level of the apparatus by the length adjustment mechanism;

then securing the base stationary to the surface by the base attachment device;

while the base is in contact with the surface (5′) and secured stationary to the surface, moving the remote end of the arm to an attachment point on the surface, the attachment point being distant from the secured stationary base, and securing the remote end to the surface at the attachment point,

while the remote end is still secured stationary at the attachment point on the surface, detaching the base attachment device from its stationary position on the surface and moving the base relatively to the attachment point by moving the arm relatively to the base or by changing the elevation level of the base by the length adjustment mechanism or by a combination thereof.

By this movement, the apparatus is always attached to the surface, either by the base being in contact with the surface and stationary secured to the surface or by the remote end of the arm being in contact with the surface and stationary secured to the surface.

For example, when the remote end of the arm is secured stationary onto the surface at an attachment point on the surface, the arm is used to drag the base, typically along the surface, towards the attachment point or to push it away. Alternatively, the remote end of the arm is secured stationary to the surface at the attachment point, and the base is moved by the length adjustment mechanism. A combination of the two functions is also possible, where the remote end of the arm is secured stationary to the surface at the attachment point, and the base is moved by the length adjustment mechanism as well as by movement of the arm.

Optionally, the base comprises a magazine with a tool, the magazine comprising a magazine coupling and the tool comprising a first tool coupling configured for cooperation with the magazine coupling for securing the tool in the magazine. The remote end of the arm or a remote end of a further arm comprises an arm coupling, and the tool comprises a second tool coupling for cooperation with the arm coupling and securing the tool to the remote end of the respective arm. In operation, the remote end of respective arm is moved to the magazine, and the arm coupling is adjusted to an orientation and position where the arm coupling, and the second tool coupling are in a mating orientation. Then, the arm coupling is locked to the tool coupling, and the first tool coupling is released from the magazine coupling for removing the tool from the magazine by the respective arm. Once the tool is secured to the respective arm, the tool can be operated by it.

For example, tools are provided for grinding the surface, optionally a wind turbine blade, filling filler into cracks and ground areas, as well as for smoothing the filler in order to obtain a repaired surface. As a further alternative, a screwing tool is provided for tightening bolts that hold blade parts together or that hold blades to the rotor centre of a wind turbine. Such operation of a tool, such as screwing tool, is potentially driven electrically, pneumatically or hydraulically. For example, the tool is provided with electrical power from the arm. Alternatively, for hydraulic or pneumatic tools, correspondingly, compressed air or hydraulic fluid is provided through tubing in or along the arm. Typically, the electrical power, compressed air or hydraulic fluid is provided to the respective arm from a grounds station. For example, such ground station is provided at the base foundation of the operation site, or alternatively, on a suitable platform, typically below the apparatus, although this is not strictly necessary.

In some useful embodiments, the base comprises a magazine with a tool or a plurality of tools. For example, the tools are different for various work steps in a sequence of work steps, for example various working steps for inspecting, cleaning, repairing and/or painting sequence. Repair examples include exchange of lightning receptors, bolt tightening, or gluing various aerodynamic add-ons onto the blade, for example vortex generators.

However, it is also possible to use the magazine with plural identical tools; this embodiment is useful if the tools have a short lifetime for a given process. For example, in case that a large surface has to be cleaned, ground, repaired or painted, a single tool may not be functional for the entire surface, and has to be exchanged to a properly working tool when the capabilities are not sufficient any more after some time of use of the tool.

Typically, the apparatus comprises a control unit for electronically controlling the operation of the at least one arm. The electronic control unit activates the necessary actuators, for example, electrical actuators through corresponding electrical switched or pneumatic or hydraulic actuators through corresponding valves.

In some embodiments, the control unit comprises a computer that is programmed for autonomously video-inspecting the site and evaluating the video signal or signal of other sensors, such as tactile sensors or infrared sensors, and thereupon autonomously running a treatment program with the available tools, optionally after modification and adaptation of the treatment program in dependence on the evaluation. The treatment program potentially involves steps of cleaning, repairing and/or painting.

Alternatively, the control unit is connected by a data transfer line to a control station, for example remotely located. For inspection, the apparatus, for example at least one arm, comprises a video camera, and the operation site is imaged by the video camera, and the video signals transmitted from the video camera to the remote-control station and at the remote-control station inspected for remote operating the at least one arm. Also, in this advantageous operation model, the apparatus is transported to an operation site without the expert operator being needed present on site, due to the possibility of remote operation. The latter has the advantage of the control station having the possibility of handling multiple apparatus at different sites with relatively few expert operators, as the expert operators do not need to be moved to the various sites with the apparatus but can stay in the remote-control station.

In principle, the data connection line for the data communication between the remote-control station and the control unit of the apparatus can be a wireless data line using satellite transmission or a wireless data network. However, especially for offshore wind turbines, wireless data transmission lines, typically, are not satisfactory for the purpose, why a wired connection is preferred. As offshore wind turbines are equipped with not only offshore-onshore power cables but also data transmission cable on the bottom of the sea, these cables can also be used for transmitting the data between the remote-control station and the control unit for the operation of the apparatus. Optionally, for this reason, the control unit has a signal cable socket for connection to a signal cable, through which it receives operative control signals from the remote-control station. This way, the operation of the at least one arm is controlled by wired data signals.

In this operational model, the at least one wire is attached at an elevated level at the operation site, for example at an anchor location on the nacelle or the rotor of a wind turbine. The apparatus is attached to the wire or wires for moving it up to an elevated level. In order to operate the apparatus from the remote-control station, a data connection line is established between the control unit and a remote-control station, and operation signals are transmitted from the remote-control station to the control unit. This way, the arm can be remotely operated by operation signals from the remote-control station without the need of operation experts on site. This is important because transport to and from the operation site requires relatively long time, and due to the remote operation, the experts can operate optimally.

In some embodiments, especially if the apparatus comprises only one arm, the attachment device is detachable from the arm. In this case, it is automatically detached and stored in the tool magazine. For this reason, it advantageously comprises couplings identical to the first and second tool coupling. In order to detach the attachment device from the arm, the remote end of the arm is moved to the magazine and the attachment device is transferred to the magazine before the tool from the magazine is coupled to the arm.

As already mentioned, one particularly interesting operational example is where the operation site is a wind turbine with a wind turbine blade. The wire is attached to an anchoring location on the nacelle or on the central part of the rotor, and the wire extends downwards therefrom. The base is moved along the wire by remote control of the dragging unit from the control station or by lifting the base with a remotely controlled hoist, thereby increasing the elevation of the apparatus until the apparatus is abutting the wind turbine blade. By the base attachment device, the base is secured to the blade surface. While the base is secured to the blade surface and maintained stationary on the blade surface, the arm is extended, typically extended sideways, from the base, and the remote end of the arm is secured by the arm attachment device, for example arm suction cup or the arm dry adhesive pad, for remaining stationary secured to the blade surface at the attachment point. The base attachment device is released from the blade surface and moved relatively to the attachment point of the remote end of the arm by moving the arm relatively to the base or by changing the elevation level of the base by the length adjustment mechanism or by a combination thereof. For example, the base is dragged along the blade surface relatively to the attachment point or pushed away therefrom. After moving the base relatively to the remote end of the arm, the base is again secured to the blade surface by activating the base attachment device. While the base is stationary relatively to the blade surface, the arm attachment device at the remote end of the arm is than again released from the blade surface for the next action.

For example, the remote end of the arm is moved to the magazine, if present, and then coupled to the tool, and the tool is released from the magazine. Once, the tool is on the arm, it can be operated by the at least one arm while the base is secured to the blade surface. Optionally, a tool kit is provided for an apparatus system as described above, the tool kit comprising a grinding tool for grinding a surface, a dispenser tool for dispensing filling material to the surface, and a spatula tool for shaping the filling material on the surface.

Although the use of the apparatus system is exemplified herein with reference to a wind turbine, for servicing outer components of wind turbines, embodiments of the invention is of more general character, and the apparatus system is advantageously used for cleaning, painting or repairing a general vertical surface or inclined surface, for example a wall of a building.

It is pointed out that the arm can have further functions. For example, the arm can be used to lift devices from a remote location to the vicinity of the base. In addition, the arm can be used to assist another similar apparatus to move to the operation site, for example by lifting the other apparatus up from the ground, while the base is secured to the surface.

As it appears from the above, the apparatus is typically unmanned, especially useful for wind turbines, and functions as a robot, for example remotely controlled or fully automatic.

### BRIEF DESCRIPTION

Some of the embodiments will be described in detail, with references to the following Figures, wherein like designations denote like members, wherein:

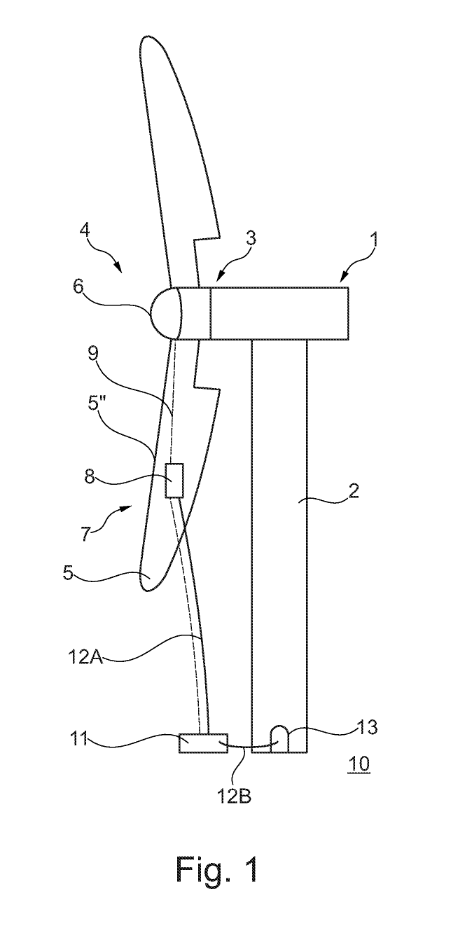

FIG. 1 is a sketch of an embodiment of the invention on a wind turbine;

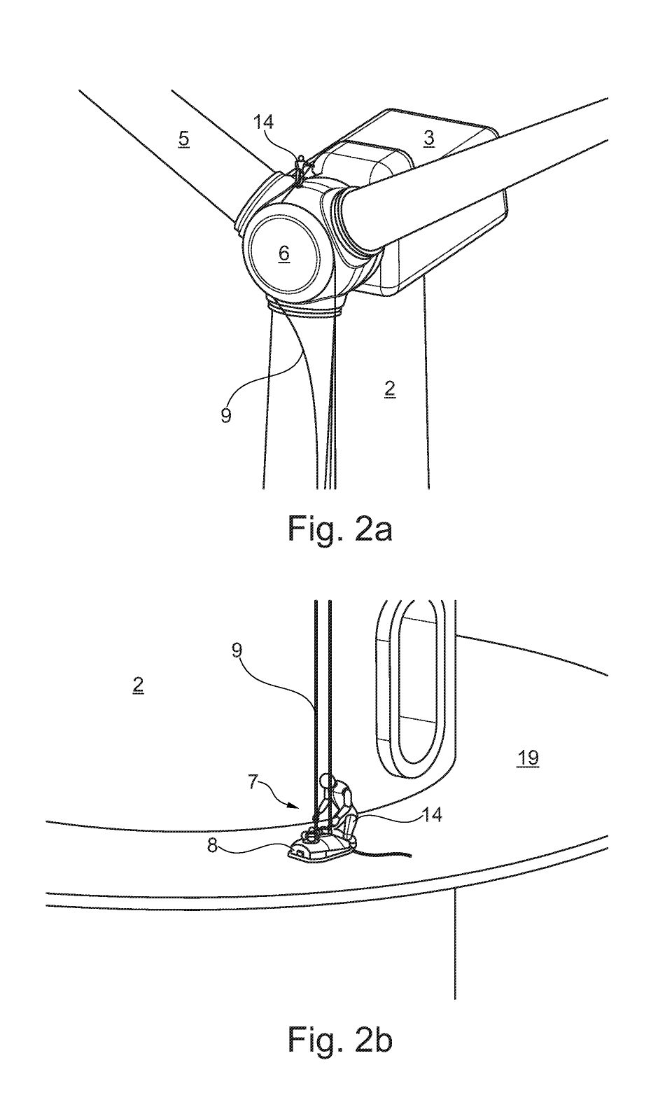

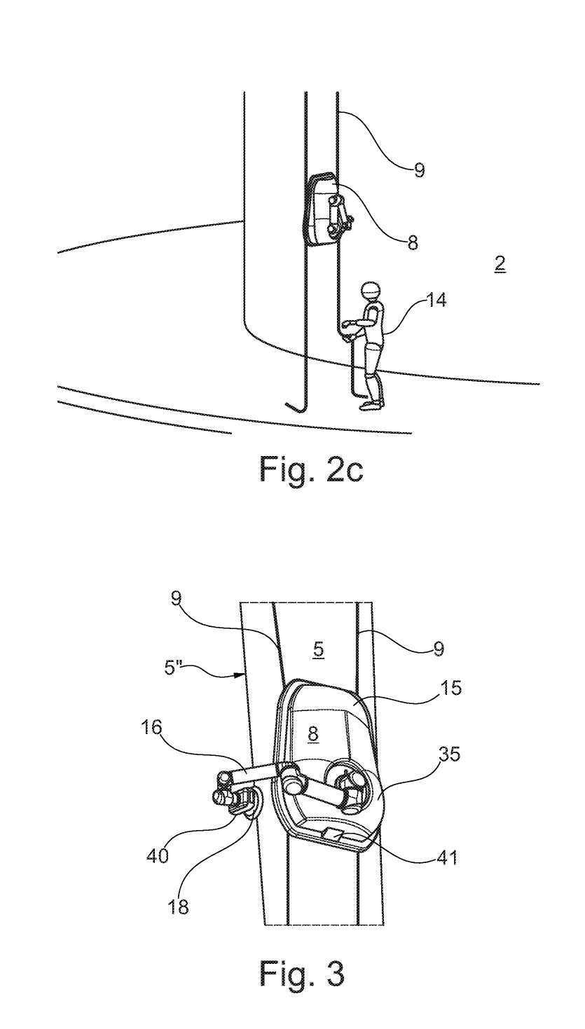

FIG. 2a illustrates mounting of the wire;

FIG. 2b illustrates mounting of the apparatus to the wire;

FIG. 2c illustrates lifting of the apparatus along the wire;

FIG. 3 illustrates the apparatus with a grinding tool on the leading edge of the blade;

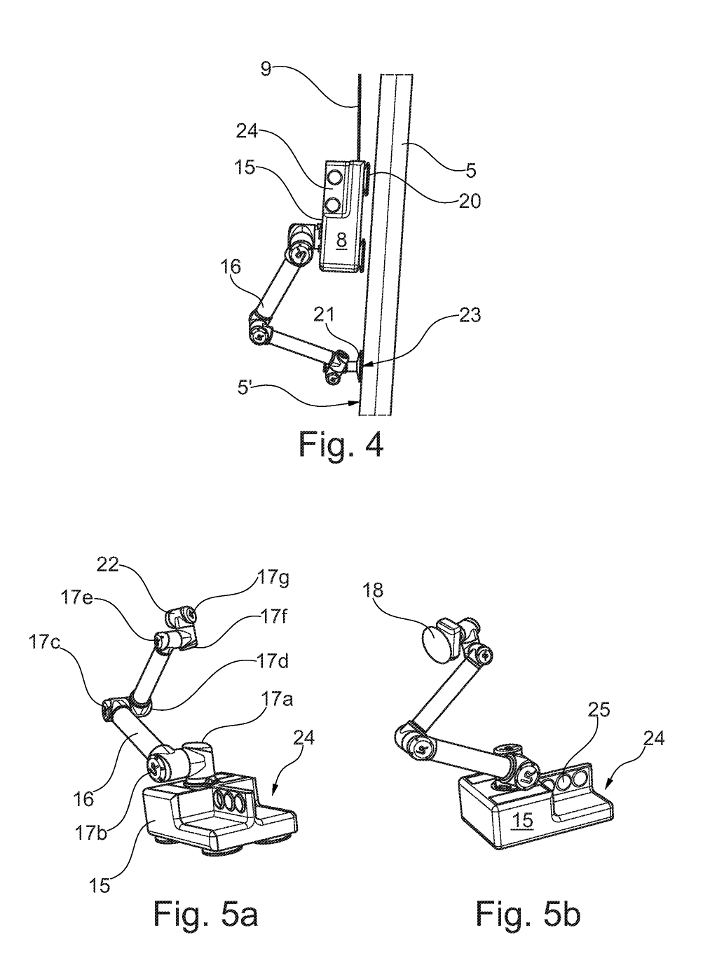

FIG. 4 illustrates an embodiment of the apparatus in greater detail with an attachment device on the blade;

FIG. 5a illustrates an apparatus without an attachment device on the arm;

FIG. 5b illustrates with an attachment device on the arm;

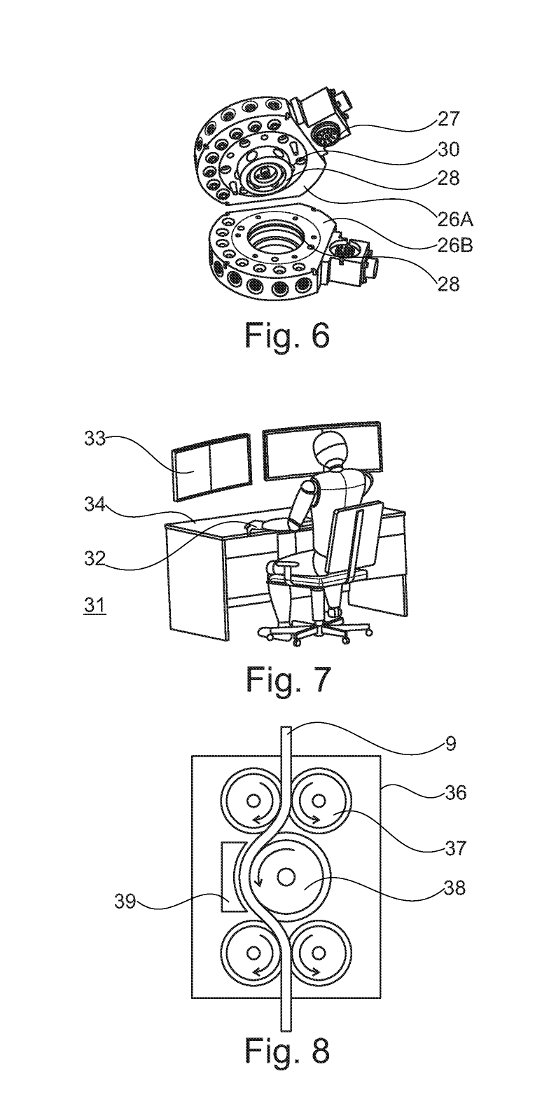

FIG. 6 is an example of couplings for coupling tools to the base;

FIG. 7 illustrates a remote-control station; and

FIG. 8 illustrates a dragging unit.

### DETAILED DESCRIPTION

FIG. 1 is an illustrative embodiment of the invention. A wind turbine 1 comprises a tower 2 and a nacelle 3 onto which a rotor 4 is rotationally coupled. The rotor 4 comprises a plurality of rotor blades 5 secured to a centre 6 of the rotor 4. A system 7 comprises an apparatus 8 and a wire 9 to which the apparatus 8 is attached. The wire 9 is secured to the centre 6 of the rotor 4 and/or to the nacelle 3 and extends downwards towards the base region 10 of the wind turbine. On the base region 10 of the wind turbine 1, a ground station 11 is provided for operation of the apparatus 8. For example, the ground station 11 provides electricity in case that the apparatus 8 is not provided with a battery system. In addition, or alternatively, it provides at least one of the following: water, cleaning liquid, compressed air for cleaning and/or for pneumatic driving of tools, hydraulic fluid, paint for painting.

Furthermore, the ground station 11 comprises a transceiver, wired or wireless, for data communication with the apparatus 8.

For example, the ground station 11 is wired by a first cable 12A to the apparatus 8 and a second cable 12B through a port 13 in the tower 2 in order to receive electrical power and/or to communicate with a remote-control station through a wired data transfer cable connection. The latter is particularly advantageous in case where the wind turbine 1 is an offshore installation where no sufficient wireless data connection is available.

An example of a method for installation is illustrated in FIG. 2a. A person or a team of persons, in the following for simplicity called the installer 14, installs the two wires 9 at the turbine top and lets the wires 9 hang down while one of the blades 5 is oriented vertically downwards. As illustrates in FIG. 2b, the installer 14 mounts the apparatus 8 onto the wires 9. The apparatus 8 is provided with dragging units through which the wires 9 extend and in which they are held in place. The dragging units are configured for running along the wires 4 and thereby drag the apparatus 8 along the wires 9 in an upwards or downwards direction as illustrated in FIG. 2c. Thereby, the dragging unit provide a length adjustment mechanism for adjusting the length of the at least one wire 9 between the apparatus 8 and the anchor location for thereby lifting or lowering the apparatus 8.

FIG. 3 illustrates an apparatus 8 in operation. The apparatus 8 comprises a base 15 from which an arm 16 extends. The arm 16 comprises seven rotational couplings 17a-g as illustrated best in FIG. 5a, giving the arm seven degrees of freedom for motion relatively to the base 15. The illustrated number of actuators is exemplary and could be different from seven. The base 15 is secured to the blade 5 while the arm 16 is provided with a grinding tool 18 for grinding the leading edge 5″ of the blade 5. Such grinding is used prior to filling possible damages with adequate filler as part of the repair of the blade surface 5′. In addition, the arm 16 comprises a video camera 40 for inspecting the site and for controlling the actions.

As an alternative to the illustrated embodiment, the wires 9 are rolled onto rollers which are part of the base 15. In this case, the wires 9 do not hang further down that the apparatus 8. As a further alternative, the apparatus 8 is secured to the wires, for example to the end of the wires, and a hoist is provided at the top of the wind turbine which is used to lift the apparatus up and down. Such exemplary embodiments are illustrated in FIG. 4.

As illustrated on FIG. 4, a base attachment device 20 is provided, for example a plurality of base suction cups, as part of the base 15 for securing the base 15 to the blade 5 surface 5′. The base suction cups are exemplary and the base attachment device 20 could be provided by other means as mentioned in the description above.

In this particular illustration, the arm 16 is provided with an arm attachment device 21, for example an arm suction cup, for securing the remote end 22 of the arm 16 to an attachment point 23 on the blade surface 5′. The arm suction cup is exemplary and the arm attachment device 20 could be provided by other means as mentioned in the description above.

When the base attachment device 20 is released from the blade surface 5′, the arm 16 can drag the base 15 towards the attachment point 23. For sake of illustration on FIG. 4, the arm 16 is directed partly downwards and partly to the side such that a drag would be skew downwards. In many situations, however, the arm 15 would be placed more sideways relatively to the base 16 such that the vertical adjustment of the position against gravity is determined by interaction with the wire 9, whereas the sideways movement is determined by drag from the arm 16 on the base 15.

FIGS. 5a and 5b illustrate the apparatus 8 in further detail, where FIG. 5a illustrated the arm 16 without tool and FIG. 5b illustrates an arm attachment device 21 coupled to the remote end 22. The base 15 comprises a magazine 24 for a plurality of tools, for example in particular for working the surface. The magazine 24 comprises a plurality of magazine couplings 25 for coupling of tools to the magazine couplings 25, in the present illustration three magazine couplings, although the number can be different depending on the requirements.

An example of a coupling with two coupling counterparts 26A, 26B is illustrated in FIG. 6. The coupling counterparts 26A, 26B are operated electrically through a connector 27 such that after mating, electrical power activates a locking mechanism 28, in this case a recess 29 into which an expandable ring of balls 30 is secured.

As illustrated in FIG. 1, optionally, the ground station 11 is wired for data transfer through a data transfer cable 9. Such cable is useful for offshore wind turbines 1 as wireless data networks are typically inadequate offshore. However, wind turbines 1 are typically connected by electrical cables for transport of electrical power as well as connected by data transfer cables to onshore stations. Such data cables are advantageously extended for transferring data between the apparatus and an onshore control station as illustrated in FIG. 7. In the remote-control station 31, an operator 32 is remotely operating the offshore located apparatus 8, for example by watching display screens 33 and operating a control panel 34. The operation of the control panel 34 causes transmission of operational command data to the control unit 35 of the offshore-located apparatus 8, the control unit 35 illustrated in FIG. 3. The control unit 35 comprises a cable connector socket 41. For simplicity, the cable itself is not shown in FIG. 3. With reference to FIG. 7, the display screens 33 can be used to watch the video sequence recorded by a video camera on the arm.

As a further option, the apparatus 8 can be operated using virtual reality tools, similar to those used for corresponding computer games. For example, the operator 32 is provided with special an operational unit, the movement of which by the operator's arm causes the arm 16 to move correspondingly.

FIG. 8 illustrates an example of a dragging unit 36, which optionally is part of the base 8. The wire 9 runs through pairs of rollers 37 which squeeze the wire 9 in between them such that rolling of the pairs of rollers 37 drags the dragging unit 36 along the wire 9, even in lifting action against gravity. The wire 9 also move around a brake roller 28, which in squeezing cooperation with a brake shoe 39 secures the wire at a predetermined position. This way, the apparatus 8 is secured against falling.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### REFERENCE NUMBERS

1 wind turbine

2 tower

3 nacelle

4 rotor

5 blades

5′ blade surface

5″ blade leading edge

6 center of rotor 4

7 system

8 apparatus

9 wire

10 base region of the wind turbine 1

11 ground station

12A first cable between ground station 11 and apparatus 8

12B second cable between ground station and data transfer cable to a remote control station 31

13 port in the tower 2 for the second cable 12B

14 installer

15 base

16 arm

17 a-g rotational actuators on arm 16

18 grinding tool

19 platform

20 base attachment device

21 arm attachment device

22 remote end of the arm 16

23 attachment point on the blade surface 5′

24 magazine for tool

25 magazine coupling

26A, 26B coupling counterparts

27 electrical connector of coupling counterparts 26A, 26B

28 locking mechanism of coupling counterparts 26A, 26B

29 recess of coupling counterparts 26A, 26B

30 expandable ring of balls of coupling counterparts 26A, 26B

31 remote control station

32 operator

33 display screens

34 control panel

35 control unit of apparatus 8

36 dragging unit

37 pairs of rollers

38 brake roller

39 brake shoe interacting with brake roller

40 video camera

41 cable socket in base 15

1. A method of operating a system at an operation site, the operation site comprising an anchor location and a surface below the anchor location; the system comprising an apparatus and at least one wire, the at least one wire being dimensioned to carry the weight of the apparatus while attached to the anchor location and extending downwards from the anchor location at a level above the apparatus; the system further comprising a length adjustment mechanism for adjusting the length of the at least one wire between the apparatus and the anchor location; the apparatus comprising a base attached to the at least one wire; the apparatus further comprising an arm extending from the base and comprising a remote end, the arm being configured for movement of the remote end relatively to the base;
wherein the remote end of the arm comprises an arm attachment device configured for securing the remote end stationary to the surface by contact of the arm attachment device with the surface;
wherein the base comprises a base attachment device, different from the arm attachment device, for securing the base stationary to the surface by contact of the base attachment device with the surface;
wherein method comprises
adjusting an elevation level of the apparatus by adjusting the length of the wire by the length adjustment mechanism;
securing the base stationary at a stationary position on the surface by the base attachment device;
while the base is in contact with the surface and secured stationary to the surface, moving the remote end of the arm to an attachment point on the surface, the attachment point being distant from the secured base, securing the remote end stationary to the surface at the attachment point,
while the remote end is still secured stationary at the attachment point and, detaching the base attachment device from its stationary position on the surface and moving the base relatively to the attachment point by moving the arm relatively to the base or by changing the elevation level of the base by the length adjustment mechanism or by a combination thereof.

2. The method according to claim 1, wherein the base comprises a dragging unit configured for dragging the base along the at least one wire; the method comprising activating the dragging unit and moving the base along the at least one wire and as a consequence causing a change of elevation of the base.

3. The method according to claim 1, wherein the apparatus comprises a control unit for electronically controlling the operation of the arm; the method comprising establishing a data connection between the control unit and a remote control station remote from the operation site, wherein the remote control station is at a distance remote from a line of sight to the operation site; transmitting operation signals from the remote control station to the control unit and operating the arm by the operation signals from the remote control station.

4. The method according to claim 3, wherein the apparatus comprises a video camera and the method comprises imaging the operation site by the video camera, transmitting the signals from the video camera to the remote control station and at the remote control station inspecting the operation site by the video camera.

5. The method according to claim 1, wherein the base comprises a magazine with a tool; the magazine comprising a magazine coupling and the tool comprising a first tool coupling configured for cooperation with the magazine coupling for securing the tool in the magazine; wherein the remote end of the arm or a remote end of a further arm comprises an arm coupling and the tool comprises a second tool coupling for cooperation with the arm coupling for securing the tool to the remote end of the arm or the further arm; wherein the method comprises driving the remote end of the arm or further arm to the magazine adjusting the arm coupling to an orientation and position where the arm coupling and the second tool coupling are in a mating orientation; locking the arm coupling to the second tool coupling, releasing the first tool coupling from the magazine coupling and removing the tool from the magazine by the arm or further arm; finally operating the tool with the arm or further arm.

6. The method according to claim 5, wherein the arm attachment device is detachable from the arm or further arm and comprises couplings identical to the first and second tool coupling and wherein the method comprises moving the arm attachment device to the magazine and transferring it to the magazine prior to coupling the tool from the magazine to the arm or further arm.

7. The method according to claim 1, wherein the operation site is a wind turbine with a wind turbine blade, and the surface is a surface of the wind turbine blade; wherein the method comprises fastening the at least one wire to a nacelle or central part of a rotor of the wind turbine and letting the wire extend downwards therefrom; while the base is attached to the at least one wire, increasing the elevation of the apparatus by the length adjustment mechanism until the apparatus is abutting the surface of the wind turbine blade.

8. The method according to claim 7, wherein the tool is a turbine blade surface repair tool, and the method comprises inspecting the blade surface with the video camera at the control centre and finding surface damage on the blade surface, repairing the surface damage by remotely operating the arm or further arm with the surface repair tool by electronic commands from the control centre to the control unit.

9. The method according to claim 3, wherein the operation site is an offshore wind turbine and the control center is at an onshore location.

10. The method according to claim 9, wherein the method comprises connecting the control unit electronically to a data signal cable extending from the offshore wind turbine to the onshore location and transmitting the control signals between the control unit and the control centre through the data signal cable.

11. A system comprising an apparatus and at least one wire, the at least one wire being dimensioned to carry the weight of the apparatus while extending downwards from an anchor location at a level above the apparatus; the system further comprising a length adjustment mechanism for adjusting the length of the at least one wire between the apparatus and the anchor location; the apparatus comprising a base attached to the at least one wire; the apparatus further comprising arm extending from the base and comprising a remote end, the arm being configured for movement of the remote end relatively to the base;
wherein the remote end of the arm comprises an arm attachment device configured for securing the remote end stationary to the surface by contact of the arm attachment device with the surface;
wherein the base comprises a base attachment device for securing the base stationary to the surface by contact of the base attachment device with the surface;
wherein the system is configured for a sequence of operations comprising,
adjusting an elevation level of the apparatus by adjusting the length of the wire by the length adjustment mechanism;
securing the base stationary to the surface by the base attachment device;
while the base is in contact with the surface and secured stationary to a stationary position the surface, moving the remote end of the arm to an attachment point on the surface, the attachment point being distant from the secured base, securing the remote end stationary to the surface at the attachment point,
while the remote end is still secured stationary at the attachment point on the surface, detaching the base attachment device from its stationary position on the surface and moving the base relatively to the attachment point by moving the arm relatively to the base or by changing the elevation level of the base by the length adjustment mechanism or by a combination thereof.

12. A system according to claim 11, wherein at least one of the base attachment device or the arm attachment device comprises a suction cup, a dry adhesive pad, an electromagnetic pad, or an electrostatic pad configured for securing to the surface.

13. The system according to claim 11, wherein the adjustment mechanism comprises a dragging unit as part of the base, the dragging unit being configured for attachment to the at least one wire and configured for dragging the base along the at least one wire.

14. The system according to claim 11, wherein the base comprises a magazine with a tool; the magazine comprising a magazine coupling, and the tool comprising a first tool coupling configured for cooperation with the magazine coupling for securing the tool in the magazine; wherein the remote end of the arm or the remote of a further arm comprises an arm coupling and the tool comprises a second tool coupling for cooperation with the arm coupling for securing the tool to the remote end of the arm or further arm.

15. The system according to claim 14, wherein the magazine comprises multiple magazine couplings configured for holding multiple tools, and wherein the multiple couplings hold multiple tools of different type.

16. A tool kit for a system according to claim 5, the tool kit comprising a grinding tool for grinding a surface, a dispenser tool for dispensing filling material to the surface, and a spatula tool for shaping the filling material on the surface.

17. The system according to claim 11 for cleaning, painting or repairing a vertical surface or an inclined surface.

18. The system according to claim 18, wherein the surface is a wall of a building.
